(19) United States
(12) Patent Application Publication
(10) Pub. No.: US 2021/0394760 A1
(43) Pub. Date: Dec. 23, 2021

(54) Method For Conducting A Motor Vehicle In An At Least Partially Automated Manner

(71) Applicants: Robert Bosch GmbH, Stuttgart-Feuerbach (DE); Daimler AG, Stuttgart (DE)

(72) Inventors: Holger Mielenz, Ostfildern (DE); Marc Eisenmann, Kirchheim/Teck (DE)

(73) Assignees: Robert Bosch GmbH, Stuttgart-Feuerbach (DE); Daimler AG, Stuttgart (DE)

(21) Appl. No.: 17/463,708

(22) Filed: Sep. 1, 2021

Related U.S. Application Data
(63) Continuation of application No. PCT/EP2020/055023, filed on Feb. 26, 2020.

(30) Foreign Application Priority Data
Mar. 7, 2019 (DE) 10 2019 105 739.6

(51) Int. Cl. B60W 30/18

(52) U.S. Cl. CPC B60W 30/18154; B60W 2720/24; B60W 2420/52; B60W 2420/42; B60W 2552/05

(57) ABSTRACT

A method for conducting a motor vehicle in an at least partially automated manner includes generating and outputting a plurality of approach signals for controlling a transverse and/or a longitudinal conduction of the motor vehicle in order to conduct the motor vehicle in at least a partially automated manner in such a way that the motor vehicle approaches a traffic junction. The method includes receiving a plurality of environmental signals which represent an environment of the motor vehicle while it approaches the traffic junction. The method determines, based on the environmental signals that the motor vehicle may continue to further approach the traffic junction, must stop, and/or must retreat. The method generates and outputs control signals for controlling the transverse and/or longitudinal conduction of the motor vehicle in order to conduct the motor vehicle in at least a partially automated manner according to the determining process.

### CROSS-REFERENCE TO RELATED APPLICATIONS

This application is a continuation of PCT International Application No. PCT/EP2020/055023, filed on Feb. 26, 2020, which claims priority under 35 U.S.C. § 119 to German Patent Application No. 102019105739.6, filed on Mar. 7, 2019.

### FIELD OF THE INVENTION

The present invention relates to a method for conducting a motor vehicle in an at least partially automated manner. The present invention further relates to a device, to a motor vehicle, to a computer program and to a machine-readable storage medium.

### BACKGROUND

Methods for longitudinal and transverse conducting of cars driving in an automated manner are, as such, known. A focus of these methods is mostly on lane-center guiding and longitudinal control with regard to a vehicle in front or further infrastructural conditions.

When a motor vehicle approaches a traffic junction, the approaching motor vehicle may block the traffic that wishes to pass the junction. Hence, there is a demand for a concept for efficient approach to a traffic junction, thereby advantageously preventing such blockage.

### SUMMARY

A method for conducting a motor vehicle in an at least partially automated manner includes generating and outputting a plurality of approach signals for controlling a transverse and/or a longitudinal conduction of the motor vehicle in order to conduct the motor vehicle in at least a partially automated manner in such a way that the motor vehicle approaches a traffic junction. The method includes receiving a plurality of environmental signals which represent an environment of the motor vehicle while it approaches the traffic junction. The method determines, based on the environmental signals that the motor vehicle may continue to further approach the traffic junction, must stop, and/or must retreat. The method generates and outputs control signals for controlling the transverse and/or longitudinal conduction of the motor vehicle in order to conduct the motor vehicle in at least a partially automated manner according to the determining process.

### BRIEF DESCRIPTION OF THE DRAWINGS

The invention will now be described by way of example with reference to the accompanying Figures, of which:

FIG. 1 is a flow chart of a method for an at least partially automated conduction of a motor vehicle;

FIG. 2 is a block diagram of a device according to an embodiment;

FIG. 3 is a schematic diagram of a motor vehicle according to an embodiment;

FIG. 4 is a block diagram of a machine-readable storage medium according to an embodiment;

FIG. 5 is a schematic diagram of a motor vehicle approaching a traffic junction according to an embodiment; and

FIG. 6 is a schematic diagram of a motor vehicle approaching a traffic junction according to another embodiment.

### DETAILED DESCRIPTION OF THE EMBODIMENT(S)

Embodiment examples of the invention are depicted in the drawings and described in the following description. In the following, the same reference numerals may be used for the same features.

In the following, the wording “conducting in an at least partially automated manner” comprises one of the following cases: assisted driving, partially automated driving, highly automated driving, fully automated driving.

Assisted driving means that a driver of the motor vehicle permanently takes over either the transverse or longitudinal conduction of the motor vehicle. The respective other driving task (i.e. controlling longitudinal or transverse conduction of the motor vehicle) is carried out automatically. This means that in assisted driving, the motor vehicle is automatically controlled either in transverse or longitudinal direction.

Partially automated driving means that in a specific situation (e.g.: driving on the motorway, driving within the limits of a parking space, overtaking an object, driving within a driving lane delimited by lane markings) and/or for a certain period of time, longitudinal and transverse conduction of the motor vehicle are controlled automatically. A driver of the motor vehicle does not have to manually control longitudinal or transverse conduction of the motor vehicle all by themselves. However, the driver has to permanently monitor the automatic control of the longitudinal and transverse conduction in order to be able to manually intervene, if necessary. The driver must be prepared to fully take over conduction of the motor vehicle at all times.

Highly automated conducting means that for a certain period of time in a specific situation (e.g.: driving on a motorway, driving within the limits of a parking space, overtaking an object, driving within a driving lane delimited by lane markings), a longitudinal and a transverse conduction of the motor vehicle are controlled automatically. A driver of the motor vehicle does not have to manually control the longitudinal and transverse conduction of the motor vehicle. The driver does not have to permanently monitor the automatic control of the longitudinal and transverse conduction in order to be able to intervene manually, if necessary. If required, a request to take over is automatically output to the driver to prompt them to take over control of the longitudinal and transverse conduction, in particular with a sufficient time margin. Thus, the driver has to be potentially able to take over the control of the longitudinal and transverse conduction. The boundaries of automatic control of longitudinal and transverse conduction are recognized automatically. In highly automated driving, it is not possible to automatically induce a minimal-risk result from each initial situation.

Fully automated driving means that in a specific situation (e.g: driving on the motorway, driving within the limits of a parking space, overtaking an object, driving within a driving lane delimited by lane markings), a longitudinal and transverse conduction of the motor vehicle are automatically controlled. A driver of the motor vehicle does not have to manually control the longitudinal and transverse conduction of the motor vehicle. The driver does not have to monitor the automatic control of the longitudinal and transverse conduction in order to be able to intervene manually, if necessary. Before the automatic control of the transverse and longitudinal conduction stops, an automatic request is sent to the driver asking them to take over the driving task (controlling the transverse and longitudinal conduction of the motor vehicle), in particular with a sufficient time margin. If the driver does not take over the driving task, a minimal-risk state is induced automatically. Boundaries of automatic control of the transverse and longitudinal conduction are recognized automatically. In all situations, it is possible to automatically reset the system to a minimum-risk state.

A traffic junction in terms of this description is for example an intersection or a crossroads. A crossroads in terms of this description is for example a sectional area of two or more intersecting traffic lanes of various streets that each continue beyond, also, if the case may be, in a laterally shifted manner. An intersection in terms of this description is for example a rectangular or angular convergence of a street with a continuous street without continuing beyond said continuous street.

The wording “to approach” is known to the person skilled in the art from, for example, the German Road Traffic Act, §8. Section 2, clause 3 of said act specifies as follows: “If the site cannot be overlooked because of poor view, one may carefully approach the crossroads or intersection until the view is clear.” Approaching the traffic junction, for example, comprises driving the motor vehicle at a maximum speed of 12 km/h, at a maximum speed of 10 km/h, at a maximum speed of 8 km/h, at a maximum speed of 6 km/h, at a maximum speed of 4 km/h, at a maximum speed of 2 km/h.

In various embodiments, an object in terms of this description is one of the following objects: a further motor vehicle, a cyclist, a pedestrian. If the term “object” is used in the present description, the wording “further motor vehicle” is always implicit, and vice versa. Substantiations made in context with an object analogously apply to a further motor vehicle, and vice versa.

According to an embodiment, a motor vehicle in terms of the description is a motor vehicle driving unmanned, a shuttle, a car, a robo-cab, a utility vehicle or the like.

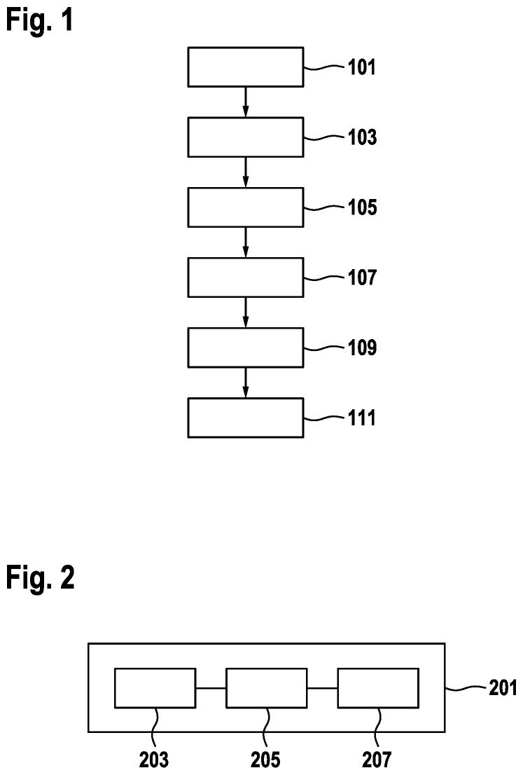

FIG. 1 shows a flow chart of a method for conducting a motor vehicle in an at least partially automated manner. In an embodiment, the method is a computer-based method. A computer-based method may also referred to as a computer-implemented method. The method comprises the following steps:

Generating 101 and outputting 103 approach signals for controlling a transverse and/or longitudinal conduction of the motor vehicle in order to conduct the motor vehicle in at least a partially automated manner in such a way that the motor vehicle approaches a traffic junction.

Receiving 105 environmental signals which represent an environment of the motor vehicle while it approaches the traffic junction.

Determining 107 based on the environmental signals that the motor vehicle may continue to further approach the traffic junction, must stop and/or retreat.

Generating 109 and outputting 111 control signals for controlling the transverse and/or longitudinal conduction of the motor vehicle based on the determining process in order to conduct the motor vehicle in at least a partially automated manner according to the determining process in such a way that the motor vehicle continues to approach the traffic junction, stops or retreats.

FIG. 2 shows a device 201. The device 201 is embodied to carry out all steps of the method according to a first aspect shown in FIG. 1. The device 201 comprises an input 203 which is embodied to receive the above- and/or below-described environmental signals.

The device 201 further comprises a processor 205, as shown in FIG. 2. The processor 205 is embodied to generate the above- and/or below-described approach signals. The processor 205 is further embodied to determine based on the environmental signals that the motor vehicle may further approach the traffic junction, must stop and/or retreat. The processor 205 is further embodied to generate the above- and/or below-described control signals; in an embodiment, it is provided that the approach signals are generated based on the received environmental signals. In an embodiment, the device 201 has a plurality of processors instead of just the processor 205.

In an embodiment, it is provided that the processor 205 is embodied to process the environmental signals in order to determine that the motor vehicle may continue to approach the traffic junction, must stop and/or retreat. Processing the environmental signals, for example, comprises carrying out an object-detection method in order to detect a further motor vehicle which comes closer to the traffic junction from a different direction than the motor vehicle. For example, it is determined that the motor vehicle has to stop or retreat if an object, in particular a further motor vehicle, is detected. The wording “the further motor vehicle” in an embodiment implicitly comprises a plurality of further motor vehicles. In an embodiment, it is provided that the processor 205 is embodied to carry out the above-described steps of determining.

The device 201 further comprises an output 207, as shown in FIG. 2. The output 207 is embodied to output the above- and/or below-described approach signals. The output 207 is further embodied to output the above- and/or below-described control signals.

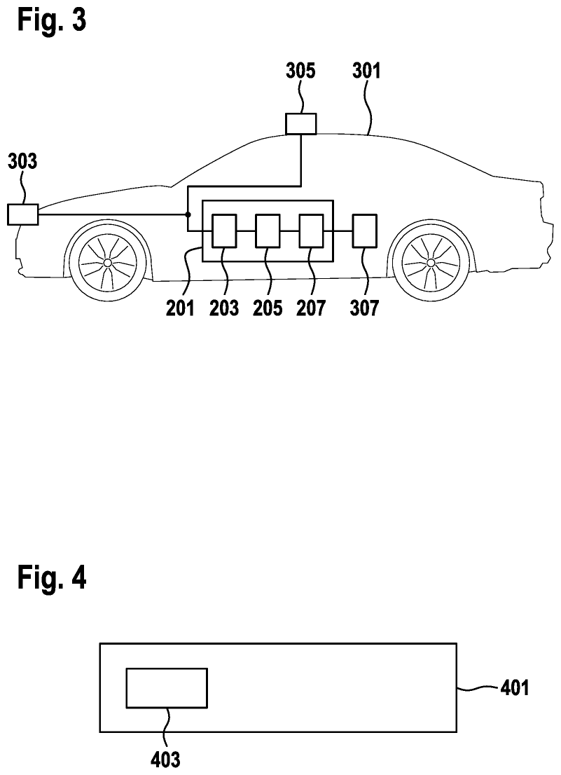

FIG. 3 shows a motor vehicle 301 according to an embodiment. The motor vehicle 301 comprises the device 201 of FIG. 2. The motor vehicle 301 comprises a front-side radar sensor 303 and a roof-side video camera 305 comprising a video sensor. The roof-side video camera 305 is, for example, a 360° video camera. The radar sensor 303 and the video camera 305 form an environmental sensor system of the motor vehicle 301. In another embodiment, in addition to or instead of the radar sensor 303 and/or the video camera 305, one or a plurality of above-described environmental sensors are provided.

The radar sensor 303 detects a front-side area of the motor vehicle 301. The radar sensor 303 provides corresponding radar signals to this detection. Correspondingly, the video camera 305 detects a certain range around the motor vehicle 301, for example a 360° range. Video signals corresponding to this detection are then provided by the video camera 305. The video signals and the radar signals thus represent an environment of the motor vehicle 301 and are thus environmental signals according to the description.

The video signals and the radar signals from the radar sensor 303 and the video camera 305 are provided to the input 203 of the device 201, as shown in FIG. 3. The input 203 receives the video signals and the radar signals. The processor 205 then carries out the corresponding steps of a method according to the first aspect shown in FIG. 1 based on the video signals and the radar signals.

According to an embodiment, an environmental sensor system of the motor vehicle 301 comprises one or a plurality of environmental sensors. An environmental sensor is for example one of the following environmental sensors: the radar sensor 303, an ultrasonic sensor, a lidar sensor, an infrared sensor, a magnetic-field sensor and a video sensor of the video camera 305. According to an embodiment, environmental signals comprise map signals of a digital map of an environment of the motor vehicle 301.

The output 207 outputs the correspondingly generated approach signals and the generated control signals to a control device 307 of the motor vehicle 301 shown in FIG. 3. The control device 307 controls a transverse and/or longitudinal conduction of the motor vehicle 301 based on the outputted approach signals and based on the outputted control signals in order to conduct the motor vehicle 301 in at least a partially automated manner based on the outputted signals. In an embodiment, it is provided that the approach signals are generated based on the received environmental signals.

FIG. 4 shows a machine-readable storage medium 401. In an embodiment, the machine-readable storage medium 401 is a non-transitory machine-readable storage medium, which includes all computer-readable media, excluding transitory, propagating signals. On the machine-readable storage medium 401, a computer program 403 is stored. The computer program 403 comprises commands that, when the computer program 403 is executed by a computer, for example by the processor 205 of the device 201, cause the computer to carry out a method according to the first aspect shown in FIG. 1.

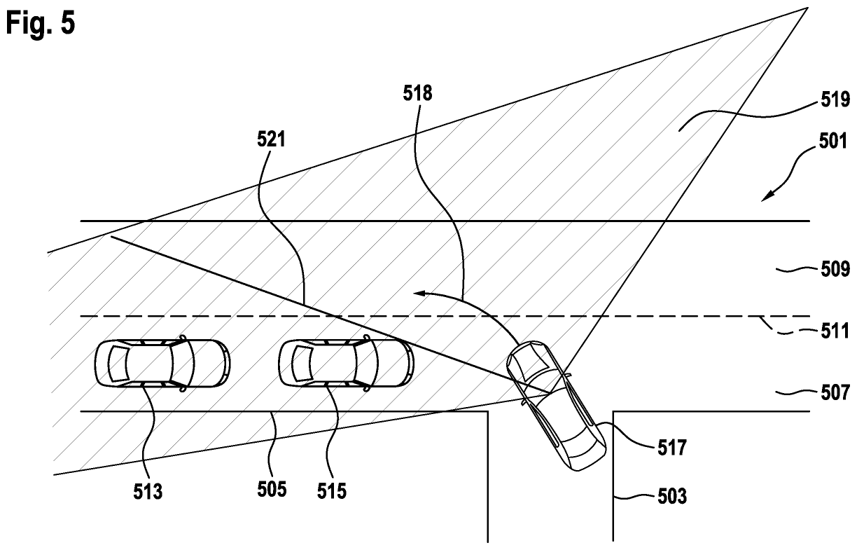

FIG. 5 shows an intersection 501 as an example for a traffic junction. The intersection 501 comprises a first street 503 which, referring to a plane in the orientation shown in FIG. 5, runs from bottom to top. The first street 503 opens into a second street 505 which, referring to the orientation of FIG. 5, runs from left to right. The second street 505 comprises a first traffic lane 507 and a second traffic lane 509. The traffic lanes 507, 509 are separated from each other by a dashed line 511. The first traffic lane 507 indicates a direction of travel for motor vehicles which, referring to the orientation shown in FIG. 5, runs from left to right. The second traffic lane 509 indicates a direction of travel for motor vehicles which, referring to the orientation shown in FIG. 5, runs from right to left.

A first parking motor vehicle 513 and a second parking motor vehicle 515 are located on the traffic lane 507 in the embodiment shown in FIG. 5. Coming from the first street 503, a motor vehicle 517 wants to turn into the second street 505 towards the left referring to an orientation shown in FIG. 5. A corresponding turn-into trajectory is symbolically shown as an arrow having reference numeral 518. The motor vehicle 517 may, for example, be the motor vehicle 301 according to FIG. 3.

The motor vehicle 517 approaches the intersection 501. The motor vehicle 517 comprises an environmental sensor system which is embodied to detect an environment of the motor vehicle 517. The motor vehicle 517 further comprises the device 201. A detection range of the environmental sensor system is symbolically shown by a shaded area having reference numeral 519.

The second parking motor vehicle 515, however, blocks detection of the environment of the motor vehicle 517 by the environmental sensor system. For example, the second parking motor vehicle 515 partially blocks a radar sensor 303 of the environmental sensor system. For example, the second parking motor vehicle 515 blocks a view for a video camera 305 of the environmental sensor system of the motor vehicle 517. The detection range 519 is thus curtailed, which is symbolically shown by a line having reference numeral 521. As a result, the environmental sensor system of the motor vehicle 517 cannot as fully capture the part of the second street 505 into which the motor vehicle 517 wants to turn into as it would be the case if the two parking motor vehicles 513, 515 were not present.

For this reason, the motor vehicle 517 approaches the intersection 501. The approach particularly has the advantage that, in case of a further oncoming motor vehicle, an adequate and timely response is still possible. In the situation shown in FIG. 5, no further motor vehicle comes closer to the intersection 501 so that the motor vehicle 517 may further approach the traffic junction, in the present case the intersection 501.

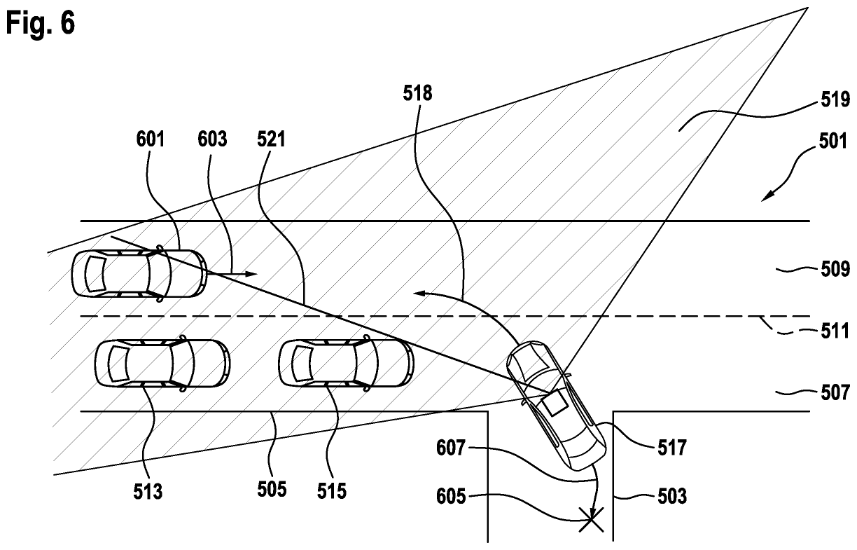

Compared to FIG. 5, FIG. 6 shows a further situation in which a further motor vehicle 601 comes closer to the intersection 501 from left to right in the orientation of FIGS. 5 and 6. A direction of travel of the further motor vehicle 601 is symbolically indicated by an arrow having reference numeral 603. The further motor vehicle 601 had to change to the second traffic lane 509 in order to be able to pass the two parking motor vehicles 513, 515. Due to the approach, the motor vehicle 517 has partially proceeded to the second traffic lane 509, thereby blocking a passing of the further motor vehicle 601.

As a result, according to the concept described herein, it is determined that the motor vehicle 517 has to stop and to retreat. For this purpose, it is provided that a rearward retreat position 605 is identified to which the motor vehicle 517 is to retreat. Moreover, a trajectory 607 is determined which guides the motor vehicle 517 to the rearward retreat position 605. Correspondingly, the motor vehicle 517 retreats to the rearward retreat position 605 along the trajectory 607 in at least a partially automated manner. This advantageously results in the motor vehicle 517 efficiently retreating and the further motor vehicle 601 may pass the intersection 501 without blockage. “Without blockage” particularly means that the approaching motor vehicle 517 does not block the traffic junction 501 in such a way that the object, in particular the further motor vehicle 601, cannot pass it but is forced to stop in order to prevent a collision with the approaching motor vehicle 517. In a corresponding manner, a traffic flow on the second street 505 is maintained in an advantageous manner.

The rearward retreat position 605 is in particular chosen in such a way that at least a required motor vehicle width of the further motor vehicle 601 is free on the second traffic lane 509. In the present context, “rearward” in particular refers to a direction which is opposite to the approach direction of the motor vehicle 517. “Rearward” in particular refers to an environment or to a region that, with reference to the motor vehicle 517, is at the rear of the motor vehicle 517, i.e. behind the motor vehicle 517 with reference to the travel direction of the motor vehicle 517.

The concept described herein inter alia aims at deciding during an approach of a motor vehicle 517 to a traffic junction 501 whether a traffic, such as further motor vehicle 601, in a target lane 509 of the approaching motor vehicle 517 renders it necessary that the motor vehicle 517 has to retreat along a certain trajectory 607 in order to keep up a traffic flow. Moreover, the concept described herein inter alia aims at planning and carrying out a trajectory 607 in order to have the motor vehicle 517 retreat to a retreat position 605 (rearward retreat position) to be defined. The retreat position 605 may, for example, be identified via a width of the further motor vehicle 601 which comes closer to the traffic junction 501 from a different direction than the approaching motor vehicle 517 on the traffic lane 509 intended to be occupied by the approaching motor vehicle 517.

According to an embodiment, an approach of the motor vehicle 517 to a traffic junction 501 is provided, in particular by blocking the view of an environmental sensor system of the motor vehicle 517. In an embodiment, it is provided to determine whether during an approach a further motor vehicle 601 is detected or identified. Moreover, it is provided to for example identify whether this further motor vehicle 601 has no choice with regard to an alternative traffic lane. According to an embodiment, it is provided to recognize a current traffic lane of the approaching motor vehicle 517 and a target lane of the approaching motor vehicle 517, in particular during the approach. Recognition is for example carried out by using the environmental signals.

According to an embodiment, a detection of stationary objects, such as parking motor vehicles 513, 515, and further motor vehicles 601 is provided. The detection for example comprises identifying a contour of the detected objects and/or of the detected approaching motor vehicles (further motor vehicles 601). The detection, for example, comprises determining a distance between the approaching motor vehicle 517 and the corresponding detected object.

According to an embodiment, it is provided that one or a plurality of kinematic quantities of the object(s) to be detected, such as the parking motor vehicles 513, 535 and the further motor vehicle 601, are identified and/or measured. A kinematic quantity is, for example, a speed and an acceleration.

According to an embodiment, it is provided that a detected object, for example the further motor vehicle 601, is associated with a traffic lane, for example the lane 509. According to an embodiment, it is provided to determine whether a dodging possibility exists for a detected object which comes closer to a traffic junction 501. According to an embodiment, it is provided that a behavior of an object coming closer to the traffic junction 501 is predicted. According to an embodiment, it is provided to determine whether an object coming closer to the traffic junction may pass the target lane without blockage after a stop, for example a comfort stop, of the approaching motor vehicle 517.

In case that the approaching object, for example the further motor vehicle 601, is blocked by the approaching motor vehicle 517, it is provided according to an embodiment that a rearward retreat point 605 (rearward retreat position) and an associated trajectory 607 are identified along which the approaching motor vehicle 517 retreats from the traffic lane, for example the lane 509, that is required by the oncoming traffic in order to continue. “Blocked” particularly means that the approaching motor vehicle 517 at least partially blocks a traffic lane 509 of the object, in particular of the further motor vehicle 601. This because the approaching motor vehicle 517 is at least partially located on the traffic lane 509.

In an embodiment, it is provided that a traffic lane width of the corresponding traffic lane is determined based on environmental signals where the object, in particular the further motor vehicle 601, is currently located, wherein the determining process is carried out depending on the identified traffic lane width. In an embodiment, the rearward retreat position 605 is determined depending on the identified traffic-lane width. In an embodiment, it is provided that a motor vehicle width of an oncoming motor vehicle 601 is determined based on the environmental signals, wherein the rearward retreat position 605 is identified based on the identified object width, in particular of the identified motor vehicle width. In an embodiment, it is provided that a current retreat position of the approaching motor vehicle 516 is identified in the target lane. In an embodiment, it is provided that a necessary distance is determined along which the approaching motor vehicle 517 has to retreat in order to enable the oncoming motor vehicle 601 to pass. In an embodiment, a derivation of a trajectory 607 for reaching the rearward retreat point 605 and implementation of the same is provided.

In the embodiment described above with regard to the identified traffic lane width, it is provided according to an embodiment that the following may be used for determining: a safety distance between the motor vehicle 517 and the traffic lane 509 and/or an object contour of the object, for example a contour of the further motor vehicle 601, and/or a contour of the motor vehicle 517. This means that according to an embodiment, determining is carried out depending on the identified traffic lane width and a safety distance between the motor vehicle 517 and the traffic lane 509 and/or an object contour of the object, for example a contour of the further motor vehicle 601, and/or a contour of the motor vehicle 517.

It is for example determined that the motor vehicle 517 may further approach the traffic junction 501 if the identified traffic lane width (in particular in consideration of (i.e. for example after corresponding addition) of the safety distance between the motor vehicle 517 and the traffic lane 509 and/or the object contour of the object, for example the contour of the further motor vehicle 601 and/or the contour of the motor vehicle 517) is larger or as large as a predefined traffic lane threshold value. In such a case, the object, in particular the further motor vehicle 601, will generally have enough space available in order to be able to dodge the approaching vehicle 517 within its own lane 509.

It is for example determined that the motor vehicle 517 must stop or retreat, if the identified traffic lane width (in particular in consideration of (i.e. for example after corresponding addition) of the safety distance between the motor vehicle 517 and the traffic lane and/or the object contour of the object, for example the contour of the further motor vehicle 601 and/or the contour of the motor vehicle 517) is smaller or as small as a predefined traffic lane threshold value. In such a case, the object, in particular the further motor vehicle 601, will generally not have enough space available anymore in order to be able to dodge the approaching vehicle 517 within its own lane 501.

According to an embodiment, it is provided that the identified traffic lane width is compared to a predetermined traffic-lane-width threshold value, wherein the determining process is carried out depending on said comparison.

According to an embodiment, it is provided that during detection of a corresponding object, e.g. a further motor vehicle 601, based on the environmental signals it is identified whether, if the motor vehicle 517 stops, the object, in particular the further motor vehicle 601, may pass the traffic junction 501 without blockage, wherein the determining process is carried out depending on identifying whether, if the motor vehicle 517 stops, the object, in particular the further motor vehicle 601, may pass the traffic junction 501 without blockage. This for example has the technical advantage that the determining process may efficiently be carried out. For example, it is determined that the motor vehicle 517 is to stop if it is identified that, when the motor vehicle 517 stops, the object, in particular the further motor vehicle 601, may pass the traffic junction 501 without blockage.

For example, it is determined that the motor vehicle 517 must retreat if it is identified that, when the motor vehicle 517 stops, the object, in particular the further motor vehicle 601, cannot pass the traffic junction 501 as it is blocked by the approaching motor vehicle 517. Provided that a stop of the motor vehicle 517 would result in the object, in particular the further motor vehicle 601, being blocked by the motor vehicle 517, it is in particular provided that it will be determined that the motor vehicle 517 has to retreat. The lane width required by the object for blockage-free passing is, according to an embodiment, carried out based on a prediction of an identified object contour along the traffic lane.

According to an embodiment, it is provided that when detecting a corresponding object, in particular a further motor vehicle 601, based on environmental signals it is detected whether a possibility of dodging exists for the object, in particular for the further motor vehicle 601, wherein the determining process is carried out depending on identifying, whether a possibility of dodging exists for the object, in particular for the further motor vehicle 601. In particular, it is provided that the approaching motor vehicle 517 must stop if it is identified that a possibility of dodging exists for the object, in particular for the further motor vehicle 601. In such a case, the motor vehicle 517 waits until the object, in particular the further motor vehicle 601, has passed the traffic junction 501 by a dodging process before the motor vehicle 517 further approaches the traffic junction 501. If it is, for example, determined, that no further possibility of dodging exists for the object, in particular the further motor vehicle 601, it is determined that the motor vehicle must retreat.

In an embodiment, it is provided that a full passage of the further motor vehicle 601 at the approaching motor vehicle 517 is determined and, after finalizing said process, a further approaching process is started.

The present invention is based on the realization that when, during approach of a motor vehicle conducted in an at least partially automated manner to a traffic junction, an environment of the motor vehicle is analyzed with regard to the question whether the motor vehicle may continue to approach the traffic junction, or must stop or retreat. Thereby, blockage situations caused by the approaching motor vehicle may advantageously be prevented in an efficient manner. This has the technical advantage that motor-vehicle safety may be improved. Furthermore, this advantageously increases customer value. Moreover, the technical advantage may be achieved that rear-end collisions may efficiently be prevented that may for example occur if a further motor vehicle has to abruptly brake due to the approaching motor vehicle so that a third motor vehicle impacts on the further motor vehicle. This in particular has the technical advantage that an efficient concept for conducting a motor vehicle in an at least partially automated manner is provided.

Technical functionalities of the method according to the first aspect result analogously from corresponding technical functionalities of the device 201 according to the second aspect and/or from technical functionalities of the motor vehicle 301 according to the third aspect, and vice versa. This particularly means that the device 201 features result from the corresponding method features, and vice versa.

What is claimed is:

1. A method for conducting a motor vehicle in an at least partially automated manner, comprising:
generating and outputting a plurality of approach signals for controlling a transverse and/or a longitudinal conduction of the motor vehicle in order to conduct the motor vehicle in at least a partially automated manner in such a way that the motor vehicle approaches a traffic junction;
receiving a plurality of environmental signals which represent an environment of the motor vehicle while it approaches the traffic junction;
determining based on the environmental signals that the motor vehicle may continue to further approach the traffic junction, must stop, and/or must retreat; and
generating and outputting control signals for controlling the transverse and/or longitudinal conduction of the motor vehicle based on the determining process in order to conduct the motor vehicle in at least a partially automated manner according to the determining process in such a way that the motor vehicle continues to approach the traffic junction, stops, or retreats.

2. The method of claim 1, wherein the environmental signals are processed in order to detect an object that comes closer to the traffic junction from a different direction than the motor vehicle.

3. The method of claim 2, wherein the determining process is carried out depending on the detection of the object.

4. The method of claim 3, wherein, when detecting the object, a lane width of a traffic lane in which the object is currently located is identified based on the environmental signals.

5. The method of claim 4, wherein the determining process is carried out depending on the lane width of the traffic lane.

6. The method of claim 3, wherein, when detecting the object, it is identified based on the environmental signals whether the object may pass the traffic junction without blockage when the motor vehicle stops.

7. The method of claim 6, wherein the determining process is carried out depending on whether the object may pass the traffic junction without blockage when the motor vehicle stops.

8. The method of claim 3, wherein, when detecting the object, it is identified based on the environmental signals whether the object has a possibility of dodging.

9. The method of claim 8, wherein the determining process is carried out depending on whether the object has the possibility of dodging.

10. The method of claim 1, wherein, when it is determined that the motor vehicle must retreat, a rearward retreat position is identified based on the environmental signals to which the motor vehicle is to retreat.

11. The method of claim 10, wherein the control signals are generated and output depending on the rearward retreat position to conduct the motor vehicle to the rearward retreat position in at least a partially automated manner.

12. The method of claim 11, wherein the environmental signals are processed in order to detect an object that comes closer to the traffic junction from a different direction than the motor vehicle.

13. The method of claim 12, wherein the determining process is carried out depending on the detection of the object.

14. The method of claim 13, wherein an object width of the object is identified based on the environmental signals and the rearward retreat position is identified based on the object width.

15. The method of claim 11, wherein, when detecting the object, a lane width of a traffic lane in which the object is currently located is identified based on the environmental signals.

16. The method of claim 15, wherein the determining process is carried out depending on the lane width of the traffic lane and the rearward retreat position is identified based on the lane width of the traffic lane.

17. The method of claim 2, wherein the object is a further motor vehicle.

18. A device embodied to carry out all steps of the method of claim 1.

19. A motor vehicle comprising the device of claim 18.

20. A machine-readable storage medium storing on a computer program comprising commands which, when executing the computer program by a computer, cause the computer to carry out the method of claim 1.
